(19) United States
(12) Patent Application Publication
(10) Pub. No.: US 2024/0398152 A1
(43) Pub. Date: Dec. 5, 2024

(54) BREWING UNIT WITH IMPROVED SEAL OF THE BREWING CHAMBER, AND METHOD FOR OPERATING SUCH A BREWING UNIT

(71) Applicant: EUGSTER / FRISMAG AG, Amriswil (CH)

(72) Inventors: Wolfgang Riessbeck, Landschlacht (CH); Patrick Egger, Niederbüren (CH); Roman Scheurer, Felben-Wellhausen (CH)

(73) Assignee: EUGSTER / FRISMAG AG, Amriswil (CH)

(21) Appl. No.: 18/690,099

(22) PCT Filed: May 10, 2022
(86) PCT No.: PCT/EP2022/062528

§ 371 Date: Mar. 7, 2024

(30) Foreign Application Priority Data
Sep. 10, 2021 (DE) 10 2021 123 550.2

(51) Int. Cl. A47J 31/44; A47J 31/46

(52) U.S. Cl. CPC A47J 31/4403; A47J 31/469

(57) ABSTRACT

The invention relates to a brewing unit (01) for a beverage preparation device for substrate portions, in particular for a coffee machine for pre-portioned coffee units, the brewing unit (01) having a support (04) and a brewing chamber (11) having at least two brewing-chamber halves (02, 03) configured to move relative to each other in a first direction (03.1), and preferably a mechanical drive for moving the brewing-chamber halves (02, 03) between an open position, in which the brewing-chamber halves (02, 03) are spaced apart from each other, and a closed position, in which the brewing-chamber halves (02, 03) are in contact with each other in the area of contact surfaces (09, 10), in particular by moving one brewing-chamber half (03) relative to the support (04). At least one brewing-chamber half (03) includes a hydraulic sealing cylinder (13) pushing the contact surfaces (09, 10) of the brewing-chamber halves (02, 03) together in the closed position so as to support a sealing effect of the brewing-chamber halves (02, 03), the sealing cylinder (13) being disposed in a fluid-conducting manner between a brewing-fluid inlet (14) of the brewing-chamber half (03) and an infusion module (07), which is preferably mounted to move in the brewing-chamber half (02, 03).

### BACKGROUND OF THE INVENTION

The present invention relates to a brewing unit for a beverage preparation device for substrate portions, in particular for a coffee machine for pre-portioned coffee units. Furthermore, the present invention relates to a beverage preparation device comprising such a brewing unit and a method for operating a brewing unit for a beverage preparation device for substrate portions, in particular for a coffee machine for pre-portioned coffee units.

A plurality of brewing units and methods for their operation in which a beverage is prepared, in particular brewed and/or leached, from a substrate portion, in particular a pre-portioned coffee unit, for example in the form of a solid capsule encased in a jacket material, using a suitable brewing unit are known in the state of the art. For this purpose, the substrate portion is typically introduced or transferred into a closable brewing chamber and enclosed in a sealed, in particular pressure-tight and fluid-tight manner by said brewing chamber before the actual brewing process begins. After opening, for example piercing, the substrate portion using basically known piercing and/or infusion modules, a brewing fluid, which is pressurized, for example, preferably hot water, can enter the opened substrate portion and brew and/or leach the beverage substrate stored there, in particular ground coffee beans or coffee powder. The resulting beverage can then be dispensed via an outlet opening.

Since the pressure or increased pressure during brewing plays a significant role in the brewing process, in particular in the case of a coffee brewing process, it is necessary that said brewing chambers of the brewing units are not only securely and reliably closed and sealed but can also be closed tightly again and again over several thousand or several thousands of brewing cycles and, moreover, that the tightness of the brewing chamber is maintained or ensured especially during the brewing process, i.e., while the brewing chamber is pressurized with the pressurized brewing fluid and, accordingly, a corresponding brewing pressure or increased pressure is built up in the brewing chamber itself. All of this must be ensured even though the installed parts of the brewing unit are all subject to a certain unavoidable manufacturing tolerance, which can increase or add up depending on the combination of individual components.

To ensure the tightness of the brewing chamber, in particular also during the brewing process with the corresponding increased pressures, mechanical closing and locking concepts which are intended to ensure that the brewing chamber remains securely closed and sealed or tight even under increased pressure conditions during every brewing process or brewing cycle, even over thousands of brewing cycles, are known in the state of the art, for example. This also means that the known closing and locking concepts typically provide for moving or movable parts of the brewing chamber, for example brewing-chamber halves that can move relative to each other, to be pushed towards each other and held in a corresponding state of tension or pressure, so that, for example, with the appropriate use of sealing means, such as sealing rings, the increased pressure or brewing pressure prevailing inside the brewing chamber during the brewing process is overcompensated to the extent that the brewing pressure is just not able to move the moving or movable parts of the brewing chamber and in particular to open the brewing chamber or lead to a leakage.

To achieve this, relatively high forces or stresses are typically required to generate the contact pressure effect, which entails corresponding disadvantages. On the one hand, high-strength, high-quality and therefore expensive materials have to be used, which must additionally be processed into correspondingly solid components in order to be able to absorb the corresponding forces and pressures. Closing the brewing chamber before the brewing process or brewing procedure—subsequent opening of the brewing chamber is often achieved automatically via restoring means, which then also have to be overcompensated or preloaded when the brewing chamber is closed—is often achieved with mechanical or electrical drives and, if necessary, maintained via mechanical locks or locking devices. However, the forces required make a manual drive sluggish and cumbersome for a user or operator. If the drive for closing the brewing chamber is electromechanical or electromotive, correspondingly large electric motors are required, which additionally require a correspondingly large amount of energy/power.

US 2001/0011502 A1 discloses a unit for preparing espresso coffee using capsules or powders, where chamber halves are moved into a loading position by operating an elastic locking means and subsequently moved into a brewing position by hydraulically shifting the cylindrical interior housing. The brewing process is started by a time-controlled valve, the brewing fluid and the hydraulic fluid being routed via separate fluid paths.

EP 3 653 087 A1 discloses a locking brewing device for capsules for a beverage machine, where a piston is able to move from an open position into a locked position against a beverage capsule in a holder cup under the pressure of a medium in a hydraulic cylinder. An infusion means sits on the piston, the infusion means being spaced apart from the beverage capsule in the open position and piercing the beverage capsule and allowing brewing fluid to enter in the locked position.

U.S. Pat. No. 5,302,407 A discloses an automatic espresso machine where a set of pressure valves enables a purely mechanical tamping and brewing of a portion of espresso powder.

### SUMMARY OF THE INVENTION

Against this background, the present invention has set itself the object of proposing a brewing unit and a method for operating a brewing unit which overcome the disadvantages in the state of the art and in particular provide a brewing unit and a method in which the brewing chamber can be closed easily and without particular effort while achieving, in particular permanently or in the long term, a secure and reliable sealing of the brewing chamber, preferably largely independent of manufacturing tolerances of the components involved.

This object is attained with a brewing unit having the features disclosed herein. Furthermore, this object is attained with the features of the method as disclosed herein.

Advantages, variants and advantageous embodiments of the invention are the subject of the following description, the figure description, the figures and the dependent claims.

Generically, a brewing unit for a beverage preparation device for substrate portions, in particular for a coffee machine for pre-portioned coffee units, is provided, the brewing unit comprising a support and a brewing chamber, the brewing chamber having at least two brewing-chamber halves configured to move relative to each other in a first direction, and drive means for moving the brewing-chamber halves between an open position, in which the brewing-chamber halves are spaced apart from each other, and a closed position, in which the brewing-chamber halves are in contact with each other at contact surfaces, in particular by moving one brewing-chamber half relative to the support.

According to the invention, it is provided that at least one brewing-chamber half comprises a hydraulic sealing cylinder pushing the contact surfaces of the brewing-chamber halves together in the closed position to support the sealing effect of the brewing-chamber halves, the sealing cylinder being disposed in a fluid-conducting manner between a brewing-fluid inlet of the brewing-chamber half and an infusion module, which is preferably movably mounted in the brewing-chamber half.

The invention is thus based on a basic concept which utilizes the brewing fluid, which is available or made available under pressure anyway, in order to apply additional force to the contact surfaces of the brewing-chamber halves before and during a brewing process, and thus very specifically during the time or the period in which pressure or increased pressure is also built up inside the brewing chamber, until finally the brewing pressure is reached, said additional force being directed in such a manner that it pushes the brewing-chamber halves and the contact surfaces towards each other and thus supporting or benefitting the closed position or sealing position of the brewing-chamber halves. In other words, this means that the invention has surprisingly recognized that a relatively low or minimal preload or a low contact pressure of the brewing-chamber halves towards each other in the closed position of the brewing-chamber halves is sufficient for a long-term safe and tight operation of the brewing unit if it can be ensured at the same time that selectively or temporarily, whenever pressure is built up inside the closed brewing chamber or shortly before such a pressure is built up, an additional secondary force is exerted on the brewing-chamber halves in such a manner that the brewing-chamber halves are forced towards each other or, otherwise, into a closed position or sealing position.

A very special achievement of the invention is to be recognized in the fact that for this purpose of temporary, targeted support or improvement of the closed position, the brewing fluid that is generated or available anyway can be utilized and thus the brewing fluid not only causes or effects the pressure in the closed brewing chamber but also builds up and maintains the corresponding counterpressure at the same time and/or at a slight delay in order to support the closed position of the brewing-chamber halves and thus ensure the tightness of the closed brewing chamber.

According to a first advantageous embodiment, mechanical locking means may be associated with at least one movable brewing-chamber half in such a manner that the brewing-chamber halves are mechanically locked in their position relative to each other when reaching the closed position. Contrary to a possibly intuitive thought, the locking means are in fact not a contradiction but an excellent addition to the basic concept according to the invention.

This is because the locking means can also be configured in such a manner that they provide or enable the closed position just so or only with a low or minimal contact pressure or contact force of the contact surfaces or the brewing-chamber halves against each other. In this case, it is particularly advantageous that the sealing cylinder positively influences the sealing effect or the contact pressure of the brewing-chamber halves against each other at just the right or necessary moment or during the right time period but does not have to provide the basic closure or the basic locking of the brewing-chamber halves in the closed position. This has the particularly advantageous effect that the brewing fluid flowing into a brewing-fluid inlet of the brewing-chamber half with the sealing cylinder first provides a corresponding increased pressure in the sealing cylinder to improve the sealing effect or the contact pressure of the brewing-chamber halves against each other before the same or the identical brewing fluid, or at least part thereof, flows into the brewing chamber or is transferred into the brewing chamber. This means that no additional fluid or hydraulic circuit separate or disconnected from some other brewing fluid flow has to be created for the sealing cylinder, which would otherwise be necessary, for example, for transferring the brewing chamber halves into the closed position in the first place.

Furthermore, the sealing cylinder may advantageously be formed between an exterior housing and an interior housing of the brewing-chamber half, the interior housing being mounted to move relative to the exterior housing. This advantageously enables a space-saving configuration. Furthermore, this allows the sealing cylinder together with the entire brewing-chamber half to also be moved or adjusted with the preferably mechanical drive means with the result that the sealing cylinder as a whole only has to execute an extremely small or almost negligible stroke, which only has to compensate for the manufacturing tolerances and/or the wear of components. In this context, “between” should be understood to mean that parts of the interior housing and the exterior housing provide essential structures for forming the sealing cylinder.

According to a further, particularly preferred embodiment, the exterior housing may be mounted in such a manner that it can be moved relative to the support and/or the other brewing chamber half with the preferably mechanical drive means. Furthermore, the exterior housing may be fixed or configured to be fixed relative to the support with the mechanical locking means which may be provided. This also has the advantage that the sealing cylinder does not act or serve as a hydraulic working cylinder that covers a significant path or stroke or a significant distance but rather accomplishes a minimal or negligible stroke in the form of a tolerance and wear compensation and is instead mainly used to transmit or exert a force. This further has the advantage that only a minimum amount of residual water or additional residual water is produced by the sealing cylinder as part of a brewing operation or brewing process.

Advantageously, the interior housing of the brewing-chamber half may also form a contact surface at one end for coming into sealing contact with the other brewing-chamber half, in particular with a contact surface of the other brewing-chamber half. This can advantageously ensure that the sealing cylinder, in particular when it is formed or disposed between the interior housing and the exterior housing, can transmit the force directly and immediately to the contact surface due to an increased pressure prevailing inside the sealing cylinder and can thus improve the sealing effect or the contact pressure of the brewing-chamber halves against each other.

In general, it should be noted with regard to this embodiment, among others, that when locking means are realized for fixing the brewing-chamber halves configured to move relative to each other in the closed position, at least a slight one-sided play between of the brewing-chamber half with the sealing cylinder and the locking means is to be realized in such a manner that a force transmission from the sealing cylinder or an increased pressure prevailing in the sealing cylinder to a contact surface of said brewing-chamber half is not prevented or blocked by the locking means and the corresponding force flow is not interrupted by the locking means.

As already indicated at various points above, a further, particularly advantageous embodiment of the brewing unit according to the invention provides that the brewing-chamber halves, the preferably mechanical drive means, the interior housing and the exterior housing are adapted to each other, in particular disposed relative to each other and dimensioned, in such a manner that when the brewing-chamber halves are mechanically moved into the closed position, in particular locked by locking means, the contact surfaces of the brewing-chamber halves push against each other with little contact force and the contact force of the contact surfaces is increased when the sealing cylinder is actuated.

As already mentioned, this has the advantage that the closed position of the brewing-chamber halves can be provided with relatively little effort and thus, for example, also well via manual operating means, such as a manually operable lever or the like, without the operator having to apply a lot of force and/or perceiving the mechanical drive means as sluggish or stiff. Overall, it contributes enormously to the ease of use of the brewing unit and thus also of the beverage preparation device if the closing of the brewing-chamber halves or the transfer of the brewing-chamber halves into the closed position requires no force or almost no force.

In a further, particularly advantageous embodiment of the brewing unit, the infusion module may comprise infusion means for penetrating a substrate portion, in particular a pre-portioned coffee unit, and introducing brewing fluid into the substrate portion or coffee unit, the infusion means being mounted to move between a retracted position and a brewing position relative to the brewing-chamber half, in particular relative to an interior housing of the brewing-chamber half. Thus, the piercing and infusion mechanism of the brewing chamber or of the brewing unit can advantageously also be provided in the brewing-chamber half providing the supporting contact-pressure and sealing effect on the contact surfaces of the brewing-chamber halves.

According to a further, particularly advantageous embodiment, the infusion means may be in fluid communication with the sealing cylinder, a hydraulic cylinder preferably being disposed between the sealing cylinder and the infusion means in a fluid-conducting manner, the working piston of the hydraulic cylinder being connected to the infusion means in such a manner that filling the hydraulic cylinder with fluid, in particular brewing fluid, leads to a movement of the infusion means in the direction of the brewing position.

If the infusion means are generally in fluid communication with the sealing cylinder, it can be ensured that the brewing fluid passes from a brewing-fluid inlet of the brewing-chamber half via the sealing cylinder to or into the infusion module and there into the infusion means, which means that, advantageously, there is exactly one fluid line or fluid path in said brewing-chamber half starting from the brewing-fluid inlet up to the infusion means. As a result, the brewing chamber, the brewing unit and the beverage preparation device as a whole can be of a particularly simple and compact design. According to another embodiment, the infusion means may advantageously also be driven or moved via a hydraulic cylinder, the hydraulic cylinder preferably also being incorporated or integrated into the exactly one fluid flow leading to the infusion means, in which case brewing fluid is, for example, initially supplied via a brewing-fluid inlet of the brewing-chamber half, then flows first into the sealing cylinder or, if applicable, also into the hydraulic cylinder simultaneously or at a partial delay, in which case a fluid-conducting connection may advantageously also exist again between the hydraulic cylinder and the infusion means or fluid-conducting means may be provided so that the brewing fluid can be passed on or forwarded at least from the working cylinder and/or from the sealing cylinder into the infusion means of the infusion module in order to be fed to a substrate portion from there.

In this advantageous embodiment, the fundamentally advantageous utilization of the available brewing fluid, which is available in particular under pressure, is further advantageously utilized as the brewing fluid also causes or effects the movement or adjustment of the infusion means of the infusion module, at least in one direction, as a hydraulic working medium in connection with the hydraulic cylinder in addition to a contact pressure or sealing effect on the brewing-chamber halves. Here, too, it is particularly advantageous that this movement or adjustment of the infusion means, in particular from a retracted position into a brewing position, takes place or is intended to take place precisely in the period during which brewing fluid is introduced into the brewing unit, in particular into the brewing-chamber half, or is supplied to the brewing-chamber half with increased pressure anyway.

Furthermore, in a particularly preferred embodiment of the brewing unit, an automatic or self-controlled valve, in particular a check valve, may be disposed downstream of the sealing cylinder and/or the hydraulic cylinder in such a fluid-conducting manner that when a brewing pressure is reached in the hydraulic cylinder and/or the sealing cylinder, fluid communication between the hydraulic cylinder and/or the sealing cylinder and the infusion module is established. Advantageously, the check valve can comprise a valve body which is preloaded against a valve seat by preloading means, preferably a spring. Particularly preferably, the valve body and the valve seat can interact in the form of a needle valve. The fluid communication with the sealing cylinder and/or the hydraulic cylinder can then be established in such a manner that the fluid must lift the valve body off the valve seat against the preload of the preloading means in order to open the valve. In this embodiment, the increased pressure at which the check valve opens is determined by the preloading means and the geometries of the valve body and the valve seat. In an embodiment without a hydraulic cylinder and with a sealing cylinder, the valve can automatically control the pressure in the sealing cylinder. In an embodiment with a sealing cylinder and a hydraulic cylinder, the valve can also control the pressure ratios in both cylinders and the advance in the hydraulic cylinder. Particularly advantageous, the automatic or self-controlled valve may be provided at the transition between the infusion means and the hydraulic cylinder and be disposed in such a manner that fluid communication between the hydraulic cylinder and the infusion means is established when a brewing pressure is reached in the hydraulic cylinder. As a result, largely automatic control of the processes within the brewing-chamber half or the brewing chamber can be achieved simply by making the brewing fluid available at a certain delivery pressure or increased pressure, the volumes and surfaces otherwise being set or determined in such a manner that, before the automatic opening of the valve, sufficient contact pressure or sufficient contact force is exerted on the contact surfaces of the brewing-chamber halves and/or the pressure in the hydraulic cylinder has ensured that the infusion means have performed, preferably against the restoring force of restoring means, in particular spring means, a hydraulic stroke which is at least sufficient to introduce the infusion means into the substrate portion.

In a further desirable embodiment of the brewing unit, recessed deformation means may be associated with the infusion means in such a manner that when the infusion means move from the retracted position into the brewing position, the deformation means cause a deformation of the surface or part of the surface of the substrate portion after or during the infusion means' penetration of the substrate portion. Thus, a possibly desirable, useful or necessary deformation of the substrate portion can also be caused directly or indirectly by the provision of the brewing fluid. Particularly preferably, the shape and movement of the deformation means may be adapted to the substrate portion in such a manner that the substrate portion is broken open when the infusion means are moved into the brewing position. Preferably, a crack structure or other similar perforations can be introduced into part of a shell or a surface material of the substrate portion. Simultaneously or alternatively, the deformation means can also serve to tamp the beverage substrate so that when the infusion means are transferred into the brewing position, the deformation means exert a tamping pressure or a tamping force on the substrate portion.

According to a further, particularly preferred embodiment, it may be provided that the interior housing of the brewing-chamber half has a rear portion with a smaller first diameter for forming the cylinder of the hydraulic cylinder and a front portion with a larger diameter for accommodating the infusion module. Particularly preferably, the rear portion with the smaller diameter may have a widening or expansion disposed on the outside of externally on the interior housing and extending, for example radially, in the direction of the exterior housing in order to preferably form the sealing cylinder between the interior housing, the widening or expansion of the interior housing and the exterior housing.

Due to the relatively small diameter in the rear portion of the interior housing for forming the cylinder of the hydraulic cylinder, it can be achieved or ensured that the working piston of the hydraulic cylinder accomplishes a sufficient stroke for transferring the infusion means and/or the deformation means into the brewing position even when using relatively little brewing fluid. The larger diameter at the front of the interior housing allows for a sufficiently large and stable infusion module, preferably including corresponding restoring means, in particular spring means, for returning the infusion means to the retracted position after completion of the brewing process.

Furthermore, the diameter or the hydraulically effective area of the sealing cylinder may advantageously be greater than the diameter or the hydraulically effective area of the hydraulic cylinder. This advantageously takes into account the fact that the very purpose of the hydraulic cylinder is to realize a stroke via the working piston, whereas the sealing cylinder is intended to generate and transmit a force with a relatively small or hardly noticeable stroke.

The object mentioned above is also attained by a beverage preparation device comprising a brewing unit according to any one of the embodiments described above. In particular, the object is attained by a coffee machine for pre-portioned coffee units, in particular coffee capsules, comprising a brewing unit according to any one of the embodiments described above.

Furthermore, the object mentioned above is attained by a method for operating a brewing unit for a beverage preparation device for substrate portions, in particular for a coffee machine for pre-portioned coffee units, the brewing unit comprising a support and a brewing chamber whose at least two brewing-chamber halves are moved between an open position and a closed position by preferably mechanical drive means, the brewing-chamber halves coming into contact with each other at contact surfaces of the respective brewing-chamber halves once a substrate portion has been received in the open position and the brewing-chamber halves have been moved into the closed position, in that the brewing-chamber halves are pushed together in the closed position so as to support a sealing effect of the brewing-chamber halves, as a hydraulic sealing cylinder disposed in at least one brewing-chamber half supports a contact pressure effect or a contact pressure of the contact surfaces of the brewing-chamber halves and the sealing cylinder is supplied with brewing fluid from a brewing-fluid inlet of the brewing-chamber half, the brewing fluid being injected into the substrate portion via an infusion module, which is preferably mounted in the brewing-chamber half in a movable manner, when a brewing pressure is reached.

In order to avoid unnecessary repetition, reference is made to the brewing unit described above with regard to the advantageous effects and the advantageous embodiments of the method. This also means that features disclosed with respect to the device as a whole are to be regarded as disclosed with respect to the method and vice versa. In summary, the method according to the invention enables the brewing-chamber halves of the brewing unit to be closed almost without force via the drive means and to be held in the closed position without permanent high mechanical pressure or contact pressure on each other, and only before and during the brewing process does the brewing fluid itself ensure that sufficient contact pressure and thus a sufficient sealing effect is achieved at the contact surfaces of the brewing-chamber halves.

According to an advantageous embodiment of the method, the pressure in the sealing cylinder may increase proportionally, preferably equally to a pressure in a hydraulic cylinder in fluid communication with the sealing cylinder, until the brewing pressure is reached, the piston of the hydraulic cylinder moving infusion means of an infusion module from a retracted position into a brewing position.

As already mentioned above, various advantageous effects can thus be achieved in a simple manner by providing the pressurized brewing fluid or brewing fluid made available under pressure, namely the improvement or the guarantee of the sealing of the brewing-chamber halves and simultaneously the transfer of the infusion means into the brewing position at the start or at the moment of injection of the brewing process.

Furthermore, the pressure in the sealing cylinder and/or the hydraulic cylinder may advantageously be kept essentially constant during the entire brewing process.

This can be achieved, for example, by pumping the brewing fluid at a rate and pressure that ensures that approximately the same amount of brewing fluid as is made up through the brewing-fluid inlet of the brewing-chamber half flows into the substrate portion or into the brewing chamber over the entire brewing process.

In a particularly advantageous manner, this enables the contact-pressure or sealing effect on the contact surfaces of the brewing-chamber halves to be maintained constantly and uniformly over the entire brewing process. Similarly, this also allows the infusion means to remain in their brewing position during the brewing process and not be moved from the brewing position back towards the retracted position by restoring means, in particular spring means. Furthermore, this also allows the valve to be kept open during the entire brewing process so that no interruptions occur during the injection of the brewing fluid.

According to a further, particularly preferred variant of the method, the pressure in the sealing cylinder and/or the hydraulic cylinder may be controlled by a self-acting, in particular automatic valve, in particular a check valve, which preferably controls the fluid flow between the hydraulic cylinder and the infusion module. In this manner, a simple fluid-related design of the brewing-chamber half can be realized in a particularly advantageous manner, which at the same time enables effective control of the modules and components via the provision of the brewing fluid. This is because it can be achieved that the hydraulic cylinder and the sealing cylinder are connected in a fluid-conducting manner or in fluid communication with each other simply via an unregulated opening or an unregulated connection, which means that only a single valve is required overall, which is additionally self-acting or automatically controlled, in order to preferably or advantageously control not only the contact pressure on the contact surfaces of the brewing-chamber halves but also the movement of the infusion means.

This also means that, advantageously, only exactly one fluid path needs to be provided and controlled in this case, namely from the brewing-fluid supply or the brewing-fluid inlet of the brewing-chamber halves via the sealing cylinder into the hydraulic cylinder—or vice versa—and from there via the infusion module and the infusion means into the brewing chamber and/or the substrate portion.

### BRIEF DESCRIPTION OF THE DRAWINGS

Advantageous aspects, embodiments and variants of the invention will be explained below with reference to merely exemplary, schematic drawings.

FIG. 1 is a sectional view of a brewing unit according to the invention with the brewing-chamber halves in the closed position and the infusion means in a retracted position;

FIG. 2 is a sectional view of a brewing unit according to the invention with the brewing-chamber halves in the closed position and the infusion means in a brewing position.

### DETAILED DESCRIPTION

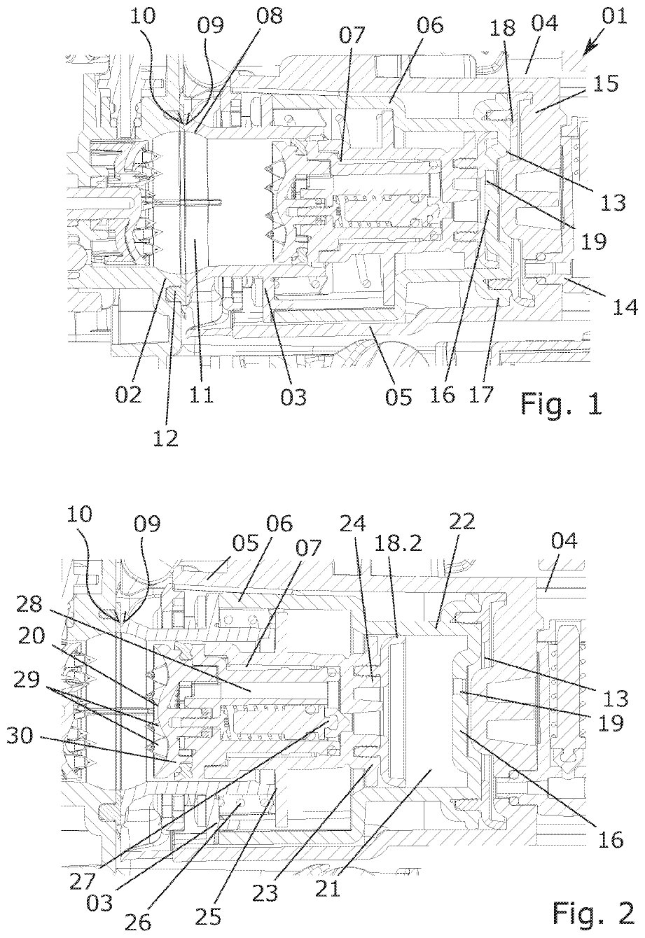

FIG. 1 shows a sectional view of a brewing unit 01 according to the invention. The brewing unit has two brewing-chamber halves 02, 03. Brewing-chamber half 03 is configured to move relative to a support 04. Brewing-chamber half 03 comprises an exterior housing 05, an interior housing 06 and an infusion module 07 mounted to move in the interior housing. A front end 08 of the interior housing 06 of brewing-chamber half 03 forms a contact surface 09 of brewing-chamber half 03, contact surface 09 interacting with an opposing contact surface 10 of brewing-chamber half 02 to form a brewing chamber 11 between the brewing-chamber halves 02, 03 in a closed position of the brewing-chamber halves 02, 03. On the side of brewing-chamber half 02, contact surface 10 is at least partially provided by sealing means 12 connected to brewing-chamber half 02.

FIG. 1 shows the brewing unit 01 in a state in which the brewing-chamber halves 02, 03 are closed and are therefore in a closed position. The closed position can preferably be achieved using mechanical drive means, which are not shown in the illustration in FIG. 1 for reasons of clarity. Furthermore, locking means can be provided which lock brewing-chamber half 03, preferably the exterior housing 05, in the illustrated relative configuration or relative position of the brewing-chamber halves 02, 03 or at least prevent brewing chamber 03 from being moved away or spaced apart from brewing chamber 02 again.

With or without locking means or locking elements, however, it can be advantageously realized that, in the state shown in FIG. 1, the contact surfaces 09, 10 only just contact each other or are in contact with each other with a relatively low contact pressure or contact force. The resulting sealing effect at the transition between the brewing-chamber halves 02, 03 would then possibly not be sufficient to maintain the tightness of the brewing-chamber halves 02, 03 if a corresponding increased pressure in the form of a brewing pressure were applied inside the brewing chamber 11 and acted on the contact surfaces 09, 10 from the inside. For this purpose, a sealing cylinder 13 is formed and disposed between the exterior housing 05 and the interior housing 06, sealing cylinder 13 being in fluid communication with a brewing-fluid inlet 14 of brewing-chamber half 03. The sealing cylinder 13 is formed by a bottom 15 of the exterior housing 05, a bottom 16 of the interior housing 06, a radial expansion 17 or a radial protrusion of the interior housing 06 and a dynamic sealing means 18, which is configured in such a manner that a pressure in the sealing cylinder 13 causes the sealing means 18 to be forced into a sealing position.

FIG. 1 conveys that a pressurized brewing fluid which enters the sealing cylinder 13 via the brewing-fluid inlet 14 also ensures that a force is exerted on the interior housing 06, in particular on the bottom 16 and the expansion 17 of the interior housing, in the direction of brewing-chamber half 02. Since contact surface 09 of brewing-chamber unit 03 is formed by an end or end portion 08 of the interior housing 06, the force that is generated or built up by the pressure within the sealing cylinder 13 is also transmitted to contact surface 09, causing it to be pressed against opposite contact surface 10 of brewing-chamber half 02. In this manner, the brewing-chamber halves 02, 03 and their contact surfaces 09, 10 are particularly advantageously forced or pressed against each other in a manner that supports the tightness or sealing of the brewing-chamber halves 02, 03 before and during a brewing process and thus in the very period before and while a corresponding increased pressure, in particular brewing pressure, builds up and sets in the brewing chamber 11.

FIG. 1 shows that an unregulated passage opening 19 is disposed in the bottom 16 of the interior housing 06, the passage opening 19 being in fluid communication with the sealing cylinder 13 and thus also in fluid communication with the brewing-fluid inlet 14. The function and advantages of this passage opening can be seen by comparing FIGS. 1 and 2.

In FIG. 2, infusion means 20 of the infusion module 07 of brewing-chamber half 03 have been moved from a retracted position to a brewing position in contrast to FIG. 1. This is achieved in a particularly advantageous manner via the hydraulic cylinder 21, which is in fluid communication with the sealing cylinder 13 via the passage opening 19. The hydraulic cylinder 21 is formed by a rear portion 22 of the interior housing 06, by the bottom 16 of the interior housing 06 and by dynamic sealing means 18.2, which in turn are force-fitted to the rear end portion 23 of the infusion module 07. The rear end portion 23 of the infusion module 07 and the dynamic sealing means 18.2 together thus form a working piston 24 which is mounted to move in the hydraulic cylinder 21 and which can be hydraulically moved from the retracted position of FIG. 1 into the brewing position of FIG. 2 by filling the hydraulic cylinder 21, in particular with brewing fluid.

The brewing position can be realized by a mechanical stop 25 of the infusion module 07 on the inner housing 06. The return of the infusion means 20 from the brewing position to the retracted position can be achieved via restoring means 26 of the infusion module 07, in particular when the hydraulic cylinder is released by reducing the internal pressure, for example as hydraulic fluid, in particular brewing fluid, drains off without a corresponding amount of hydraulic fluid or brewing fluid being made up.

When the infusion means 20 are in the brewing position, the deformation means 30, which are recessed relative to the infusion means 20, may have come into contact with a substrate portion, where they may already have effected a deformation of the surface or part of the surface of the substrate portion.

In the brewing process or, more precisely, in the preparatory phase and during the brewing process, brewing fluid is thus initially introduced into brewing-chamber half 03 through the brewing-fluid inlet 14 and fills the sealing cylinder 13 there in the embodiment of FIG. 1 and FIG. 2. As soon as the brewing fluid has reached a level or filling height that corresponds to the height of the passage opening 19, the brewing fluid will also flow into the hydraulic cylinder 21 unhindered or uninhibited. As the supply of pressurized brewing fluid continues, a corresponding pressure will build up in the sealing cylinder 13, which is reduced to some extent or at least initially increases slowly due to the fact that, at least for a certain period of time, the working piston 24 in the hydraulic cylinder 21 undergoes a movement or displacement and thus moves the infusion means 20 of the infusion module 07 from the retracted position towards the brewing position. As soon as the infusion means have reached the mechanical stop 25 and have thus assumed the brewing position, the pressure in the sealing cylinder 13 and in the hydraulic cylinder 21 will continue to rise as the supply of pressurized brewing fluid continues. This leads to a corresponding contact pressure effect on the contact surfaces 09, 10 and to the effect that the infusion means 20 are held in the brewing position. As soon as a predefined brewing pressure prevails or is exceeded in the hydraulic cylinder 21, the check valve 27 at the transition between the hydraulic cylinder 21 and the infusion means 20 is opened and pressurized brewing fluid can enter the infusion tips 29 via the infusion ducts 28 and from there into a substrate portion or coffee unit.

During the brewing process, pressurized brewing fluid is advantageously made up through the brewing fluid inlet 14 so that the pressures in the sealing cylinder 13 and the hydraulic cylinder 21 are maintained and brewing fluid can pass through the open check valve 27 for a desired time or a desired period of time. The check valve 27 thus controls both the increased pressure in the sealing cylinder 13 and the pressure in the hydraulic cylinder 21.

If the inflow of pressurized brewing fluid via the brewing fluid inlet 14 is stopped and, if applicable, a drain valve is opened, the restoring means 26 return the infusion means 20 from the brewing position back into the retracted position, as a result of which any remaining brewing fluid can be returned or discharged from the hydraulic cylinder 21. This also reduces the contact pressure between the contact surfaces 09, 10.

### REFERENCE SIGNS

01 brewing unit
02 brewing-chamber half
03 brewing-chamber half
03.1 first direction
04 support
05 exterior housing
06 interior housing
07 infusion module
08 end
09 contact surface
10 contact surface
11 brewing chamber
12 sealing means
13 sealing cylinder
14 brewing-fluid inlet/brewing fluid supply
15 bottom
16 bottom
17 protrusion
18 sealing means
18.2 sealing means
19 passage opening
20 infusion means
21 hydraulic cylinder
22 portion
23 end portion
24 working piston
25 stop
26 restoring means
27 check valve
28 infusion ducts
29 infusion tips
30 deformation means

1. A brewing unit (01) for a beverage preparation device for substrate portions, the brewing unit (01) comprising a support (04) and a brewing chamber (11) having at least two brewing-chamber halves (02, 03) configured to move relative to each other in a first direction (03.1), and mechanical drive means for moving the brewing-chamber halves (02, 03) between an open position, in which the brewing-chamber halves (02, 03) are spaced apart from each other, and a closed position, in which the brewing-chamber halves (02, 03) are in contact with each other in the area of contact surfaces (09, 10), by moving one brewing-chamber half (03) relative to the support (04),
wherein
at least one brewing-chamber half (03) comprises a hydraulic sealing cylinder (13) pushing the contact surfaces (09, 10) of the brewing-chamber halves (02, 03) together in the closed position so as to support a sealing effect of the brewing-chamber halves (02, 03), the sealing cylinder executing an extremely small or almost negligible stroke in the form of tolerance and wear compensation, the sealing cylinder (13) being disposed in a fluid-conducting manner between a brewing-fluid inlet (14) of the brewing-chamber half (03) and an infusion module (07), the infusion module (07) being mounted to move in the brewing-chamber half (02, 03).

2. The brewing unit according to claim 1,
wherein
mechanical locking means are associated with at least one movable brewing-chamber half (02, 03) in such a manner that the brewing-chamber halves (02, 03) are mechanically locked in their position relative to each other when reaching the closed position.

3. The brewing unit according to claim 1,
wherein
the sealing cylinder (13) is formed between an exterior housing (05) and an interior housing (06) of the brewing-chamber half (03), the interior housing (05) being mounted to move relative to the exterior housing (05).

4. The brewing unit according to claim 3,
wherein
the exterior housing (05) is mounted to move relative to the support (04) and/or the other brewing-chamber half (02) with the mechanical drive means.

5. The brewing unit according to claim 3,
wherein
the interior housing (06) has a contact surface (09, 10) on one end for coming into sealing contact with the other brewing-chamber half (02, 03).

6. The brewing unit according to claim 3
wherein
the brewing-chamber halves (02, 03), the mechanical drive means, the interior housing (06) and the exterior housing (05) are adapted to each other, and disposed relative to each other and dimensioned in such a manner that when the brewing-chamber halves (02, 03) are moved into the closed position, and locked by the locking means, the contact surfaces (09, 10) of the brewing-chamber halves (02, 03) push against each other with a low contact force and the contact force of the contact surfaces (09, 10) is increased when the sealing cylinder (13) is actuated.

7. The brewing unit according to claim 1,
wherein
the infusion module (07) comprises infusion means (20) for penetrating a substrate portion and injecting brewing fluid into the substrate portion, the infusion means (20) being mounted to move between a retracted position and a brewing position relative to the brewing-chamber half (03) relative to the interior housing (06).

8. The brewing unit according to claim 7,
wherein
the infusion means (20) are in fluid communication with the sealing cylinder (13), a hydraulic cylinder (21) being disposed in a fluid-conducting manner between the sealing cylinder (13) and the infusion means (20), a working piston (24) of the hydraulic cylinder (21) being connected to the infusion means (20) in such a manner that filling the hydraulic cylinder (21) with fluid causes the infusion means (20) to move in the direction of the brewing position.

9. The brewing unit according to claim 8,
further comprising
an automatic or self-controlled valve at the transition between the infusion means (20) and the hydraulic cylinder (21), said valve being disposed in such a manner that fluid communication between the hydraulic cylinder (21) and the infusion means (20) is established when a brewing pressure in the hydraulic cylinder (21) is reached.

10. The brewing unit according to claim 7,
wherein
recessed deformation means (30) are associated with the infusion means (20) in such a manner that the deformation means (30) deform the surface of the substrate portion when the infusion means (20) move from the retracted position into the brewing position after or during the penetration of the infusion means (20) into the substrate portion.

11. The brewing unit according to claim 9,
wherein
the pressure in the sealing cylinder (13) is controlled by an automatic valve, in particular between the infusion means (20) and the hydraulic cylinder (21).

12. The brewing unit according to claim 8,
wherein
the interior housing (06) of the brewing-chamber half (02, 03) comprises a rear portion (22) having a smaller first diameter for forming the cylinder of the hydraulic cylinder (21) and a front portion having a larger diameter for accommodating the infusion module (07).

13. The brewing unit according to claim 8,
wherein
the diameter or the hydraulically effective surface of the sealing cylinder (13) is greater than the diameter or the hydraulically effective surface of the hydraulic cylinder (21).

14. A method for operating a brewing unit (01) for a beverage preparation device for substrate portions, the brewing unit (01) comprising a support (04) and a brewing chamber (01) whose at least two brewing-chamber halves (02, 03) are moved by mechanical drive means between an open position and a closed position, the brewing-chamber halves (02, 03) coming into contact with each other at contact surfaces once a substrate portion has been received in the open position and the brewing-chamber halves (02, 03) have been moved into the closed position,
wherein
the brewing-chamber halves (02, 03) are pushed together in the closed position so as to support a sealing effect of the brewing-chamber halves (02, 03), as a hydraulic sealing cylinder (13) disposed in at least one brewing-chamber half (02, 03) supports a contact pressure effect of the contact surfaces of the brewing-chamber halves (02, 03) and the sealing cylinder (13) is supplied with brewing fluid from a brewing-fluid inlet (14) of the brewing-chamber half (02, 03), the sealing cylinder executing an extremely small or almost negligible stroke in the form of tolerance and wear compensation, and when a brewing pressure is reached, the brewing fluid is injected into the substrate portion via an infusion module (07), which is mounted to move in the brewing-chamber half (02, 03).

15. The method according to claim 14,
wherein
until the brewing pressure is reached, the pressure in the sealing cylinder (13) is proportional to a pressure in a hydraulic cylinder (21) which is in fluid communication therewith and whose piston moves infusion means (20) of an infusion module (07) from a retracted position into a brewing position.

16. The method according to claim 14,
wherein
the pressure in the sealing cylinder (13) is kept essentially constant during the entire brewing process.

17. The method according to claim 14,
wherein
the pressure in the sealing cylinder (13) and/or the hydraulic cylinder (21) is controlled by a self-acting valve, in particular a chock valve(27), which controls the fluid flow between the hydraulic cylinder (21) and the infusion module (07).

18. The brewing unit according to claim 1, wherein the beverage preparation device is a coffee machine for pre-portioned coffee units.
